(19) United States
(12) Patent Application Publication
(10) Pub. No.: US 2026/0072198 A1
(43) Pub. Date: Mar. 12, 2026

(54) Refractive Solar Concentrator With Concentration Ratio To Achieve Specific Irradiance And Temperature Levels In The Target

(71) Applicant: Exowatt, Inc., Miami, FL (US)

(72) Inventors: Ehsan Ordouie, Miami, FL (US); Ralf Leutz, Miami, FL (US)

(21) Appl. No.: 19/323,720

(22) Filed: Sep. 9, 2025

Related U.S. Application Data
(60) Provisional application No. 63/692,668, filed on Sep. 9, 2024.

(51) Int. Cl. G02B 1/04; B29D 11/00; G02B 3/08

(52) U.S. Cl. CPC G02B 1/041; B29D 11/00269; G02B 3/08

(57) ABSTRACT

An example Fresnel lens design has four segments A-D of equal area which can be manufactured from the same mold, before being rotated and assembled in the pattern shown. The segments A-D have flanges, appropriate to facilitate assembly and structural integrity during the lifetime of the lens.

### CROSS-REFERENCE TO RELATED APPLICATIONS

This application claims benefit of U.S. Provisional Ser. No. 63/692,668 filed Sep. 9, 2024, which is incorporated herein by reference in its entirety and for all purposes.

### FIELD

The technology herein relates to lens design, and more particularly to Fresnel lens design for a solar concentration system.

### BACKGROUND & SUMMARY

In the early 19th Century, a French scientist named Augustin-Jean Fresnel (pronounced “Fren-nel”) who devoted his career to studying the wave properties of light was asked by the French government to solve a problem—how to make it easier for mariners to see lighthouses from greater distances out at sea. At that time, lighthouses were lit by kerosine lamps that did not produce much light. Lenses were often used to focus the light into beams, but the lenses were very thick and resulted in substantial light loss. Instead of trying to figure out how to make the lamps more powerful, Fresnel started doing experiments on thinner optical systems that could beam the light from the kerosine lamp in the direction of ships out at sea.

Fresnel had studied the properties of a conventional plano-convex lens (one side planar, the other size convex) used to focus light, and knew that the lens'refraction or light bending effects were caused by different light rays (wavefronts) passing through different thicknesses of glass on their paths to/from the curved convex surface of the lens. Fresnel thought about how to decrease the amount of glass the light had to pass through in order to reach that curved convex surface. Fresnel's insight was that the same light bending and focusing effects could be obtained if the “center” thickness of the lens was simply left out and the lens was instead deconstructed into a series of prism-shaped rings each mimicking a portion of the curved concave surface of the plano-convex lens. Fresnel applied this principle to collimate the light from the lighthouse's kerosine lamp into a light beam of parallel light rays. His lens idea revolutionized lighthouses at the time by reducing the light loss through the optical system and thus substantially increasing the distance from which mariners could see the light from an existing kerosine lamp.

Fresnel lens remain in common use today for all sorts of applications including handheld plastic magnifying glasses, illumination systems, computer displays, photography, projection systems and more. An advantage of Fresnel lenses is that they can be constructed by etching, stamping or molding grooves in a planar (flat) sheet of large dimensions comprising a durable material such as acrylic or polycarbonate plastic. Due to the availability of Fresnel lenses in large sizes, they are an ideal choice for focusing sunlight to heat a sample placed at the focal point of the lens. They are also commonly used to collect light for solar heat collectors. See e.g., Xie, “Concentrated solar energy applications using Fresnel lenses: A review”, Renewable and Sustainable Energy Reviews, Volume 15, Issue 6, August 2011, Pages 2588-2606 doi.org/10.1016/j.rser.2011.03.031. Aspherical Fresnel lenses may provide a better light concentrating ability than spherical Fresnel lenses. See e.g., Edmund Scientific Optics, “Fresnel Lens Review” (2012) youtu.be/pNOGMfmti4w?si=lpTZST_ALEVSdz6Z.

However, there are still significant challenges to using Fresnel lenses successfully for solar collection. In particular, the conventional wisdom is that Fresnel lens operate efficiently only if the light source is directed normal to the Fresnel prismatic surface, and that off-axis light sources are not magnified efficiently. Since the sun constantly moves across in arc in the sky, the conventional wisdom is thus that the orientation of the Fresnel lens must be tracked in two orthogonal axes to the position of the sun. Dual axis tracking systems unfortunately tend to be expensive and complicated.

Additionally, Fresnel lenses can comprise very large sheets of thin material such as acrylic or polycarbonate. They need to be adequately supported (e.g., in frames) to prevent damage and then efficiently tracked/moved with motion of the sun. This is theoretically straightforward but expensive and complicated as a practical matter.

Thus conventional Fresnel lens panels have been used for solar concentration system, but with some disadvantages. Improved Fresnel lens designs specifically for solar concentration systems are desirable.

### BRIEF DESCRIPTION OF THE DRAWINGS

FIG. 1 shows a top view in plan of an example Fresnel lens.

FIG. 2 shows a top view in plan of section a.

FIG. 3 shows a cross-sectional view taken along “E” of FIG. 1.

### DETAILED DESCRIPTION OF NON-LIMITING EMBODIMENTS

One challenge is to design a solar concentration system requiring a certain concentration ratio of the impinging radiation and related temperature in the focal area of the optical system, plus a certain amount of energy (or, irradiance) at the concentration and temperature levels described.

Concentration and temperature: In particular, the solar concentration system should deliver a certain concentration ratio of the impinging radiation and related temperature in the focal area of the optical system.

Energy: The solar concentration system should also deliver a certain amount of energy to the focal area of the optical system, for the thermodynamic machine subsequent to the optical system to function.

Concentration and temperature: The temperature a solar concentrator can reach depends on (a) its concentration ratio, and (b) on the absorber efficiency. Typically, to reach 1,300K degrees in the focal area, the concentration ratio needs to be 400× (or ‘suns’, describing the ratio of lens entry aperture over target area).

Energy: To the effect of collecting a sufficient amount of energy, a Fresnel lens solar concentrator the lens will exceed a square area of (2.5 m)².

Concentration and temperature: In one embodiment, the concentration and temperature challenge is addressed by a Fresnel lens with an aspect ratio (focal length over diagonal) ranging from 0.6 to 1.0.

In an example embodiment, the Fresnel lens is made of a clear, highly transmissive and UV-stable material to being able to deliver the concentration, and the amount of energy needed. Two materials can be used to manufacture the lens and satisfy specifications regarding clarity, transmissivity and UV-stability, which are Polymethylmethacrylate (PMMA) and silicones like Polydimethylsiloxanes (PDMS), delivered in a silicone-on-glass (SOG) sandwich, as substrate on a glass superstrate.

An example Fresnel lens designed in shown in FIG. 1. Its four segments A-D are of equal area and can be manufactured from the same mold, before being rotated and assembled in the pattern shown in the Figure. The segments A-D have flanges, appropriate to facilitate assembly and structural integrity during the lifetime of the lens.

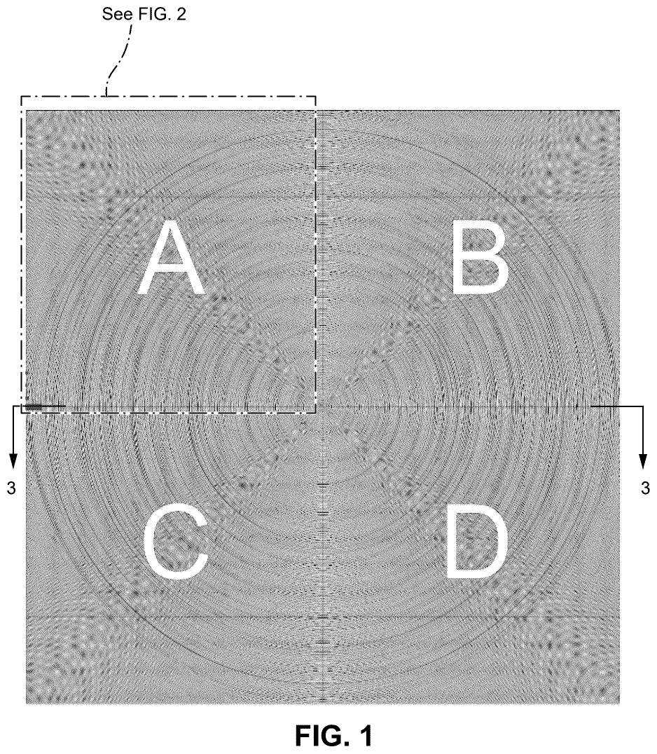

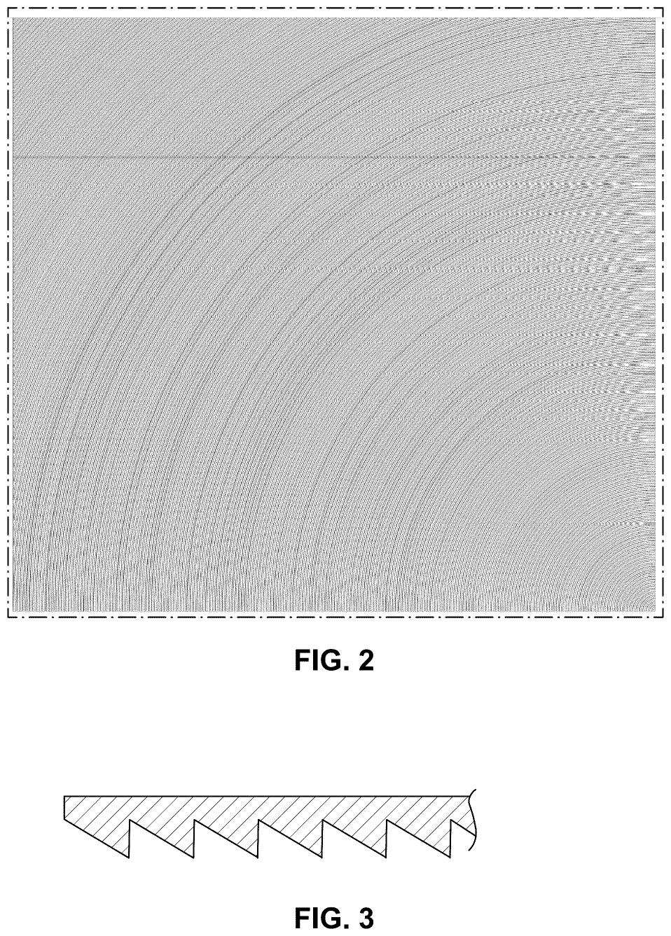

FIG. 2 shows a part of the cross-section of the lens, as referenced in FIG. 1.

As every prism ring (seen in FIG. 2) can carry its refractive power independently of the refractive power of the other prism rings, the lens can be meticulously designed regarding its overall focal length, and its overall concentration ratio, optimizing for the challenges of concentration and temperature, and energy. This design procedure and the resulting lens may be described as ‘freeform’.

The Fresnel lens concentrator's dimensions and total area are unique. Previously built Fresnel lens concentrators have been smaller. The four segments A-D carry built-in flanges for assembly and structural integrity, making the manufacturing concept unique in its relation to the structural integrity of the system the concentrator forms a central element of. The ‘freeform’ design of the lens addressing the challenges of concentration and temperature, and energy is highly innovative for planar Fresnel lenses. While multi-focal Fresnel lenses are known, a ‘freeform’ design geared at optimizing the challenges of concentration and temperature, and energy is unique.

FIG. 3 shows an example cross-section view.

All patents and publications cited herein are incorporated by reference as if expressly set forth.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A lens arrangement comprising:
a clear, highly transmissive and UV-stable material configured to deliver concentration and amount of energy;
the material being molded into an article that bears plural prism rings;
wherein a first prism ring is molded to carry its refractive power independently of the refractive power of at least one other molded prism ring.

2. The lens arrangement of claim 1 wherein the article comprises plural materials.

3. The lens arrangement of claim 2 wherein the plural materials are formulated to satisfy specifications regarding clarity, transmissivity and UV-stability.

4. The lens arrangement of claim 2 wherein a first of the plural materials comprises Polymethylmethacrylate (PMMA) and a second of the plural materials comprises a silicone.

5. The lens arrangement of claim 4 wherein the second of the plural materials comprises a Polydimethylsiloxane (PDMS).

6. The lens arrangement of claim 1 wherein the article is delivered in a silicone-on-glass (SOG) sandwich, as substrate on a glass superstrate.

7. The lens arrangement of claim 1 wherein the lens arrangement is freeform designed and configured regarding its overall focal length, overall concentration ratio, optimizing for challenges of concentration and temperature, and energy.

8. The lens arrangement of claim 1 wherein the article has plural segments manufactured from the same mold, before being rotated and assembled.

9. The lens arrangement of claim 8 wherein the plural segments have flanges, configured to facilitate assembly and structural integrity during lifetime of the lens.

10. The lens arrangement of claim 8 wherein the plural segments are of equal area.

11. A method of manufacturing a lens arrangement comprising:
molding a clear, highly transmissive and UV-stable material configured to deliver concentration and amount of energy into an article that bears plural prism rings, including molding a first prism ring to carry its refractive power independently of the refractive power of at least one other molded prism ring.

12. The method of claim 11 wherein molding comprises molding the article out of plural materials.

13. The method of claim 12 further including formulating the plural materials to satisfy specifications regarding clarity, transmissivity and UV-stability.

14. The method of claim 12 wherein a first of the plural materials comprises Polymethylmethacrylate (PMMA) and a second of the plural materials comprises a silicone.

15. The method of claim 14 wherein the second of the plural materials comprises a Polydimethylsiloxane (PDMS).

16. The method of claim 11 further including delivering the article in a silicone-on-glass (SOG) sandwich, as substrate on a glass superstrate.

17. The method of claim 11 wherein the lens arrangement is freeform designed and configured regarding its overall focal length, overall concentration ratio, optimizing for the challenges of concentration and temperature, and energy.

18. The method of claim 11 further including assembling the article from plural segments manufactured from the same mold before being rotated and assembled.

19. The method of claim 18 wherein the plural segments have flanges, configured to facilitate assembly and structural integrity during the lifetime of the lens.

20. The method of claim 18 wherein the plural segments are of equal area.
